(19) United States
(12) Patent Application Publication
(10) Pub. No.: US 2026/0267081 A1
(43) Pub. Date: Sep. 10, 2026

(54) FIBER OPTIC CONNECTOR WITH BOOT OR COUPLER THAT IS REMOVEABLE AND/OR MOUNTABLE AFTER AFFIXATION OF THE FIBER OPTIC CONNECTOR TO A CABLE

(71) Applicant: CommScope Technologies LLC, Claremont, NC (US)

(72) Inventors: Johan GEENS, Bunsbeek (BE); Patrick Jacques Ann DIEPSTRATEN, Heusden-Zolder (BE); Yu LU, Eden Prairie, MN (US); Ryan KOSTECKA, Waconia, MN (US)

(73) Assignee: CommScope Technologies LLC, Claremont, NC (US)

(21) Appl. No.: 19/165,838

(22) PCT Filed: Mar. 15, 2024
(86) PCT No.: PCT/US2024/020201

§ 371 Date: Sep. 16, 2025

Related U.S. Application Data
(60) Provisional application No. 63/490,662, filed on Mar. 16, 2023.
(60) Provisional application No. 63/512,002, filed on Jul. 5, 2023.
(60) Provisional application No. 63/558,474, filed on Feb. 27, 2024.

(51) Int. Cl. G02B 6/38

(52) U.S. Cl. CPC G02B 6/38875; G02B 6/3846; G02B 6/3889; G02B 6/3894

(57) ABSTRACT

A connectorized cable assembly including a pre-terminated cable having a connector core connected to an end of a fiber optic cable. The connectorized cable assembly also include turn-to-secure coupler and/or a boot configured to be: a) mounted over the connector core after the connector core has been affixed at the end of the fiber optic cable; and/or b) removable from the connector core after the connector core has been affixed at the end of the fiber optic cable.

### CROSS-REFERENCE TO RELATED APPLICATIONS

This application is being filed on Mar. 15, 2024, as a PCT International Application and claims the benefit of U.S. Provisional Patent Application No. 63/490,662, filed on Mar. 16, 2023; and claims the benefit of U.S. Provisional Patent Application No. 63/512,002 filed on Jul. 5, 2023; and claims the benefit of U.S. Provisional Patent Application No. 63/558,474 filed on Feb. 27, 2024, the disclosures of which are hereby incorporated by reference in their entireties.

### TECHNICAL FIELD

The present disclosure relates generally to fiber optic connectors.

### BACKGROUND

Fiber optic communication systems are becoming prevalent in part because service providers want to deliver high bandwidth communication capabilities (e.g., data and voice) to customers. Fiber optic communication systems employ a network of fiber optic cables to transmit large volumes of data and voice signals over relatively long distances. Optical fiber connectors are an important part of most fiber optic communication systems. Fiber optic connectors allow two optical fibers to be quickly optically connected without requiring a splice. Fiber optic connectors can be used to optically interconnect two lengths of optical fiber. Fiber optic connectors can also be used to interconnect lengths of optical fiber to passive and active equipment.

A typical fiber optic connector includes a ferrule assembly supported at a distal end of a connector housing. A spring is used to bias the ferrule assembly in a distal direction relative to the connector housing. The ferrule functions to support an end portion of at least one optical fiber (in the case of a multi-fiber ferrule, the ends of multiple fibers are supported). The ferrule has a distal end face at which a polished end of the optical fiber is located. When two fiber optic connectors are interconnected, the distal end faces of the ferrules abut one another and the ferrules are forced proximally relative to their respective connector housings against the bias of their respective springs. With the fiber optic connectors connected, their respective optical fibers are coaxially aligned such that the end faces of the optical fibers directly oppose one another. In this way, an optical signal can be transmitted from optical fiber to optical fiber through the aligned end faces of the optical fibers. For many fiber optic connector styles, alignment between two fiber optic connectors is provided through the use of an intermediate fiber optic adapter.

Ruggedized (i.e., hardened) fiber optic connection systems include fiber optic connectors and fiber optic adapters suitable for outside environmental use. These types of systems are typically environmentally sealed and include robust fastening arrangements suitable for withstanding relatively large pull loading and side loading. Example ruggedized fiber optic connection systems are disclosed by U.S. Pat. Nos. 7,467,896; 7,744,288 and 8,556,520.

It will be appreciated that a number of different types of ruggedized fiber optic connectors are available for outside environmental use. International Publication No. WO2015/028433 discloses a system for making fiber optic connectors in which a number of different ruggedized outer assemblies having different form-factors or configurations can be selectively mounted on a pre-terminated cable such that the pre-terminated cable can be customized to be compatible with a particular style or type of fiber optic connector or fiber optic adapter. Other systems are disclosed by PCT International Publication Nos. WO2021/041305 and WO2020/236512.

### SUMMARY

One aspect of the present disclosure relates to a connectorized cable assembly including a fiber optic cable having an end and a connector core affixed at the end of the fiber optic cable. The fiber optic cable includes a jacket containing at least one optical fiber and at least one strength member. The connector core has a front end and a rear end. The strength member is anchored relative to the connector core at the rear end of the connector core when the connector core is affixed at the end of the fiber optic cable. The rear end of the connector core is sealed relative to the jacket of the fiber optic cable when the connector core is affixed at the end of the fiber optic cable. A seal is carried by the connector core at an exterior of the connector core and a ferrule is positioned adjacent the front end of the connector core. The ferrule supports a front end of the optical fiber or supports an optical fiber stub spliced to the optical fiber. The connectorized cable assembly also includes a boot configured to be: a) mounted over the connector core after the connector core has been affixed at the end of the fiber optic cable; and/or b) removable from the connector core after the connector core has been affixed at the end of the fiber optic cable. The boot is configured for providing bend protection to the fiber optic cable adjacent the rear end of the connector core. The boot is not configured to provide sealing about the fiber optic cable.

Another aspect of the present disclosure relates to a connectorized cable assembly with a coupler having an integrated cable protection assembly that is configured to be mounted on the connector core after termination, or removed after termination, wherein the coupler has: a) a front extension that is pushed on to the connector core after the connector core has been affixed at the end of the fiber optic cable, until the front piece snaps into position, or is prevented from being pushed on any further due to a stop; and b) a rear extension that extends to protect the pre-terminated cable, that is moveable between an open, and a closed position. In one example, the rear extension includes two pieces pivotally connected to a rear end of the front extension. In one example, the hinges define hinge axes oriented transverse with respect to a central axis of the cable and the front extension.

A further aspect of the present disclosure relates to a connectorized cable assembly. The connectorized cable assembly includes a fiber optic cable having an end and including a jacket containing at least one optical fiber and at least one strength member. The connectorized cable assembly also includes a connector core affixed at the end of the fiber optic cable. The connector core has a front end and a rear end with the strength member of the fiber optic cable being anchored relative to the connector core at the rear end of the connector core when the connector core is affixed at the end of the fiber optic cable. The rear end of the connector core is sealed relative to the jacket of the fiber optic cable when the connector core is affixed at the end of the fiber optic cable. A seal is carried by the connector core at an exterior of the connector core. A ferrule is positioned adjacent the front end of the connector core; the ferrule supporting a front end of the optical fiber or supporting an optical fiber stub spliced to the optical fiber. The connectorized cable assembly also includes a turn-to-secure coupler for: a) securing the connector core in a fiber optic adapter wherein the seal provides sealing between the connector core and the fiber optic adapter; or b) securing a converter over the connector core wherein the seal provides sealing between the connector core and the converter; or c) securing a dust cap over the front end of the connector core wherein the seal provides sealing between the connector core and the dust cap. The turn-to-secure coupler mounts directly over the connector core and is configured to be: a) mounted over the connector core after the connector core has been affixed at the end of the fiber optic cable; and/or b) removable from the connector core after the connector core has been affixed at the end of the fiber optic cable.

A variety of additional inventive aspects will be set forth in the description that follows. The inventive aspects can relate to individual features and to combinations of features. It is to be understood that both the foregoing general description and the following detailed description are exemplary and explanatory only and are not restrictive of the broad inventive concepts upon which the examples disclosed herein are based.

### BRIEF DESCRIPTION OF THE DRAWINGS

FIG. 1 illustrates a fiber optic connection system in accordance with the principles of the present disclosure;

FIG. 2 is an exploded view of a connectorized cable assembly of the fiber optic connection system of FIG. 1;

FIG. 3 is an opened and laid-flat view of a boot and turn-to-secure coupler of the connectorized cable assembly of FIG. 2;

FIG. 4 is a cross-sectional view of the connectorized cable assembly of FIG. 2 with the boot and turn-to-secure coupler installed on a pre-terminated connector core of the connectorized cable assembly;

FIG. 5 is a cross-sectional view of the connectorized cable assembly of FIG. 2 with the boot and turn-to-secure coupler removed from the pre-terminated connector core of the connectorized cable assembly;

FIG. 6 is a rear, perspective view of an SC release sleeve that can be mounted over the pre-terminated connector core of the connectorized cable assembly;

FIG. 7 depicts the connectorized cable assembly of FIG. 2 with the boot and turn-to-secure coupler removed and with the SC release sleeve installed over the pre-terminated connector core, the re-terminated connector core is shown inserted within a port of an SC adapter that is part of a bank of SC adapters provided at a fiber optic enclosure;

FIG. 8 depicts another boot that can be installed and/or removed from the pre-terminated connector core after cable termination;

FIG. 9 is another example of a coupler and boot assembly in accordance with the principles of the present disclosure adapted to be snapped onto the pre-terminated connector core of the connectorized cable assembly of FIG. 5;

FIG. 10A depicts another coupler and boot assembly in accordance with the principle of the present disclosure shown installed over the pre-terminated connector core of the connectorized cable assembly FIG. 5;

FIG. 10B depicts the coupler and boot assembly of FIG. 10A, with the coupler and boot assembly detached from the pre-terminated connector core of the connectorized cable assembly of FIG. 5;

FIG. 11 is a cross-sectional view of the coupler and boot assembly of FIGS. 10A and 10B, with the coupler and boot assembly installed on the pre-terminated connector core of the connectorized cable assembly of FIG. 5.

FIG. 12A depicts a second embodiment of the coupler and boot assembly of FIGS. 10A, 10B, and 11, with the boot over molded on the coupler and the coupler and boot assembly shown mounted on the pre-terminated connector core of the connectorized cable assembly of FIG. 5;

FIG. 12B depicts the coupler and boot assembly of FIG. 12A detached from the pre-terminated connector core of the connectorized cable assembly of FIG. 5;

FIG. 13A is another coupler installed on the pre-terminated connector core of the connectorized cable assembly of FIG. 5, the coupler including a rear extension portion that extends over the cable of the connectorized cable assembly;

FIG. 13B depicts the coupler of FIG. 13A removed from the pre-terminated connector core of the connectorized cable assembly of FIG. 5;

FIG. 14 is a cross-sectional view of the coupler of FIGS. 13A and 13B installed on the pre-terminated connector core of the connectorized cable assembly of FIG. 5;

FIG. 15A depicts a coupler with integrated cable protection removed from the connectorized cable assembly of FIG. 5;

FIG. 15B depicts the coupler with integrated cable protection of FIG. 15A being installed on the connectorized cable assembly of FIG. 5;

FIG. 16A depicts the coupler with integrated cable protection of FIGS. 15A and 15B fully installed on the connectorized cable assembly of FIG. 5;

FIG. 16B depicts the fully installed coupler with integrated cable protection of FIG. 16A on the connectorized cable assembly of FIG. 5, with a dust cap installed over a pre-terminated connector core and secured to the coupler;

FIG. 17 is a cross-sectional view of the assembly of FIG. 16B;

FIG. 18 depicts another SC release sleeve adapted to fit over a connector core (e.g., a connector core of the type shown at FIG. 5);

FIG. 19 depicts a connector assembly including the SC release sleeve of FIG. 18 mounted over a connector core;

FIG. 20 is a cross-sectional view taken longitudinally through the connector assembly of FIG. 19;

FIG. 21 depicts an alternative turn-to-secure coupler adapted for use with a connector core ((e.g., a connector core of the type shown at FIG. 5); and

FIG. 22 depicts the turn-to-secure coupler of FIG. 21 with a side cover displaced (e.g., detached, disconnected, removed, pivoted away from, etc.) from a main coupler body of the turn-to-secure coupler.

### DETAILED DESCRIPTION

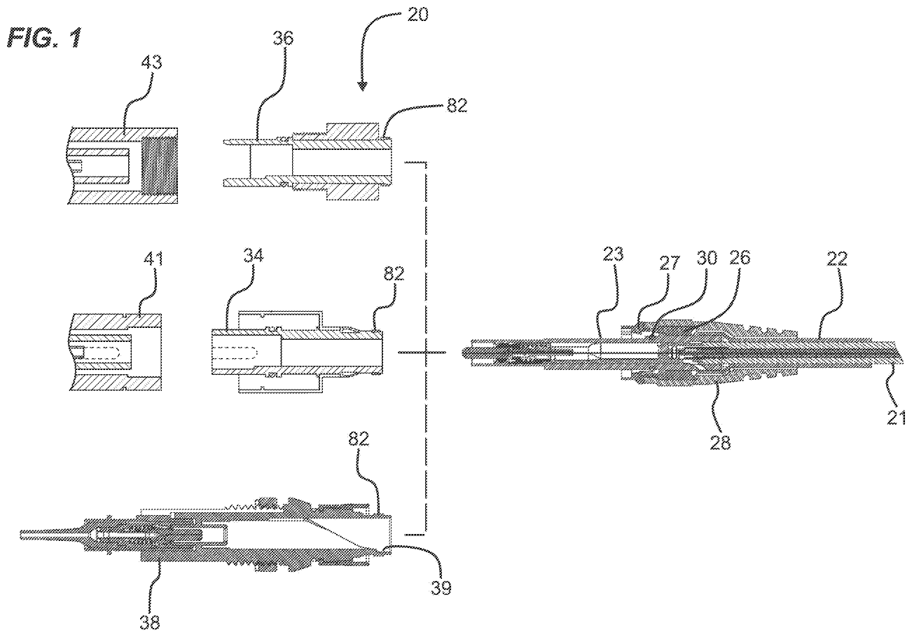

FIG. 1 illustrates an example fiber optic connection system 20 in accordance with the principles of the present disclosure. The fiber optic connection system 20 allows a pre-terminated fiber optic cable 22 to be readily configured in one of any number of different connector configurations. The different connector configurations can include connector configurations having different connector housings/shrouds, different keying arrangements for keying with different styles or types of fiber optic adapters or fiber optic connectors, different fasteners compatible with different fiber optic adapters and fiber optic connectors, and the like. In certain examples, the different connector arrangements can include a plurality of different hardened (i.e., ruggedized) connector arrangements adapted to be compatible with different styles or types of hardened fiber optic connectors or hardened fiber optic adapters. It will be appreciated that the pre-terminated cable 22 can be fitted with a selected one of the different outer connector arrangements either in the field or in the factory to render the pre-terminated fiber optic cable compatible with a particular type of connector system (e.g., the pre-terminated fiber optic cable with the selected connector assembly mounted thereon is compatible and mateable with a particular fiber optic adapter style and/or a particular fiber optic connector style). In certain examples, the pre-terminate cable can include a connector core that is directly compatible with a fiber optic adapter.

Referring still to FIG. 1, the pre-terminated cable 22 includes a fiber optic cable 21 and a connector core 23 terminating one end of the fiber optic cable 21. A turn-to-secure coupler 26 is rotatably mounted on the connector core 23, and a strain relief boot 28 is mounted on the turn-to-secure coupler 26. In one example, the strain relief boot is configured to not provide sealing about the fiber optic cable 21. The turn-to-secure coupler 26 as well as the strain relief boot 28 are preferably configured to be: a) mounted over the connector core 23 after the connector core 23 has been affixed at the end of the fiber optic cable 21; and/or b) removable from the connector core 23 after the connector core 23 has been affixed at the end of the fiber optic cable 21. The strain relief boot 28 is configured for providing bend protection to the fiber optic cable 21 adjacent the rear end of the connector core 23.

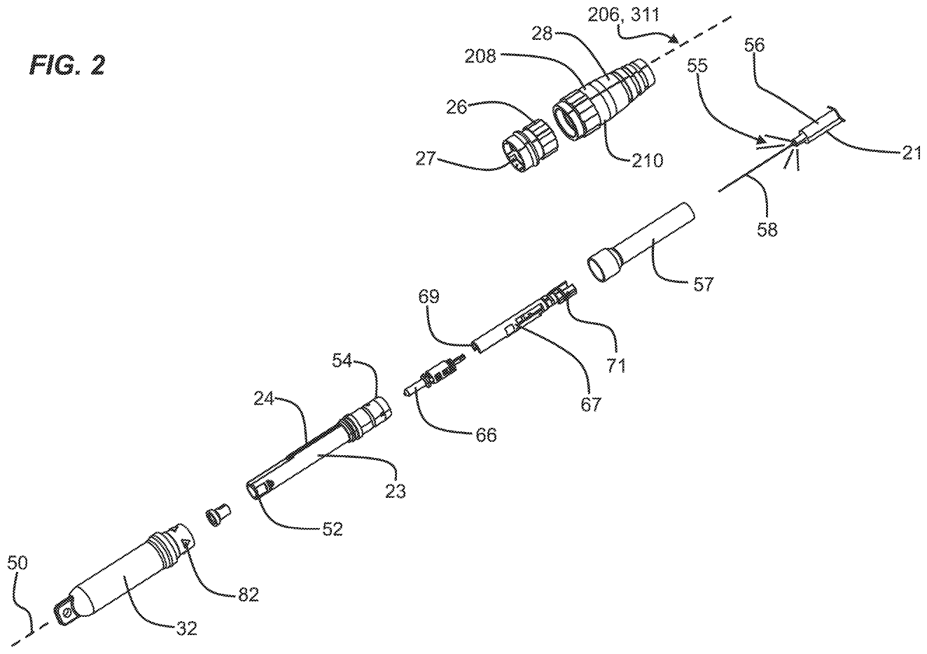

The turn-to-secure coupler 26 mounts on the connector core 23 adjacent a rear end of the connector core 23 (i.e., adjacent at end to which the cable is secured). A seal 30 is mounted on the connector core 23. The fiber optic connector assembly system 20 also includes a number of different components, arrangements, assemblies or the like that can be selected and individually mounted on the connector core 23 and secured to the connector core 23 by the turn-to-secure coupler 26. The seal 30 can be configured to seal against the components, arrangements or assemblies when the components, arrangements or assemblies are coupled to the connector core 23. The various components, arrangements, and assemblies are depicted as including a dust cap 32 (see FIG. 2), a first hardened connector shroud and fastener arrangement 34, a second hardened connector shroud and fastener arrangement 36, and a small form-factor fiber optic adapter 38 having at least one ruggedized port for directly receiving the connector core 23.

It will be appreciated that the dust cap 32 can be secured over the connector core 23 to protect the connector core 23 and the terminated optical fiber or fibers supported thereby prior to coupling the connector core 23 with any of its mating components such as the first hardened connector shroud and fastener arrangement 34, the second hardened connector shroud and fastener arrangement 36 or the small form-factor fiber optic adapter 38. It will be appreciated that the dust cap 32 is required to be removed from the connector core 23 prior to coupling the connector core with any of its mating components.

A first fiber optic connector assembly that results when the first hardened connector shroud and fastener arrangement 34 is mounted on the connector core 23 is compatible and mateable with a FastConnect™ fiber optic adapter 41 (shown schematically at FIG. 1) sold by Huawei Technologies Company Ltd. (see U.S. Pat. No. 9,557,493, which is hereby incorporated by reference in its entirety). A second fiber optic connector assembly that results when the second hardened connector shroud and fastening arrangement 36 is mounted on the connector core 23 is configured to be compatible with an Opti Tap™ fiber optic adapter 43 (shown schematically at FIG. 1) by Corning Cable Systems LLC (e.g., see U.S. Pat. No. 7,090,407, which is hereby incorporated by reference in its entirety). The small form-factor fiber optic adapter 38 includes a ruggedized port 39 adapted to directly receive the connector core 23 without requiring the use of an intermediate shroud for keying, alignment or sealing. Further details regarding the fiber optic adapter 38 are disclosed by PCT International Publication No. WO 2021/041,305 which is incorporated by reference in its entirety.

It will be appreciated that a fiber optic cable is pre-terminated by mounting a structure at the end of the cable that presents the optical fiber or fibers for optical connection by a de-mateable optical connection. For example, a fiber optic cable can be pre-terminated by mounting a ferrule at the end of the optical fiber or fibers of the cable in preparation for presenting the optical fiber as part of a ferruled optical connector. In other examples, a housing or other structure can be attached to the fiber optic cable and can function to align or position the optical fiber without the use of a ferrule as in the case of a ferrule-less fiber optic connector. In the depicted example, the fiber optic cable 21 is pre-terminated by mounting the connector core 23 at the end of the fiber optic cable 21 prior to assembling any of the hardened arrangements 34, 36 over the connector core 23 or over the fiber optic cable 21.

Referring to FIG. 2, the connector core 23 includes a connector core housing 24 that is elongate along a length that extends along a longitudinal axis 50. The connector core housing 24 includes a front plug end 52 positioned opposite from a rear cable attachment end 54. The front plug end 52 optionally has a form factor compatible with an SC type fiber optic adapter; but could have other form factors as well such as an LC connector form factor compatible with an LC fiber optic adapter. The fiber optic cable 21 is attached (e.g., secured, fixed, anchored) to the connector core 23 at the rear cable attachment end 54 of the connector core housing 24. For example, strength members 55 (e.g., yarn type strength members such Aramid yarn or fiberglass) can be attached to the connector core 23 at the rear cable attachment end 54 by adhesive (e.g., epoxy), crimping or other means. The fiber optic cable 21 includes an outer jacket 56. The outer jacket 56 of the fiber optic cable 22 can be secured to the cable attachment end 54 of the connector core housing 24 by a sleeve 57 such as a shape memory sleeve (e.g., a heat-shrink sleeve) and additionally by adhesive injected within the core housing 24. In certain examples, the heat-shrink sleeve can include an interior layer of adhesive for bonding the heat-shrink sleeve to the outer jacket 56 and to the connector core housing 24. The turn-to-secure coupler 26 is mounted over the connector core housing 24 and can be turned (e.g., rotated) relative to the connector core housing 24 about the longitudinal axis 50. The turn-to-secure coupler 26 is captured axially between an outer stop 47 (e.g., a shoulder) of the housing 24 and the front end of the sleeve 57 such that the coupler 26 is axially retained on the housing 24. The boot optionally can be turned in unison with the coupler 26 about the axis 50.

An optical fiber structure 58 includes a first section 60 routed longitudinally through the outer jacket 56 of the fiber optic cable 21 and at least a portion of the core housing 24 and a second section 62 routed through a ferrule 66 positioned at the front plug end 52. The second section 62 of the optical fiber structure 58 defines a fiber tip 64 at the front plug end 52 of the connector core housing 24. A front portion of the second section 62 of the optical fiber structure 58 is secured and supported within the ferrule 66. The ferrule 66 is spring biased in a forward direction relative to the connector core body 24 by a spring 68. An inner body 67 mounts within the connector core housing 24 and includes a front end 69 that functions as a spring stop and a rear end 71 that can include structure for use in securing strength members of the fiber optic cable 22 to the connector core 23.

In the case where the ferrule 66 is directly mounted on the optical fiber of the fiber optic cable 21, the optical fiber structure 58 is an uninterrupted length of optical fiber where the first and second sections 60, 62 are all part of one continuous optical fiber. In a splice-on version of the connector arrangement, the second section 62 can be formed by a segment of optical fiber that is optically spliced (e.g., fusion or mechanically spliced) to an optical fiber of the fiber optic cable 21 which forms the first section 60. In certain examples, the optical splice can be located within the interior of the connector core housing 24.

The connector core housing 24 includes the exterior stop 47 (e.g., a projection, a wall, rib, a shoulder or the like) positioned adjacent the cable attachment end 54 of the connector core housing 24. The stop 47 can include a forwardly facing positive stop surface 72 and a rearwardly facing positive stop surface 74. The surface 74 provides for axial retention of the coupler 26, while the surface 72 provides a positive stop adapted for engaging a corresponding stop surface of the small form-factor fiber optic adapter 38 for stopping insertion of the connector core 23 into the small form-factor adapter 38 at a predetermined, fully inserted location. In the depicted example, the coupler 26 includes an internal positive stop feature (e.g., a shoulder such as an annular shoulder, projection, tab, etc.) having a forwardly facing surface 75 that opposes the rearwardly facing positive stop surface 74 such that engagement and/or opposition between the surfaces 74, 75 prevents the coupler 26 from being removed from (e.g., slid off) the core housing 24 in a forward direction with respect to the core housing 24.

The turn-to-secure coupler 26 includes an interior coupling arrangement 27 adapted to couple with mating exterior coupling arrangement 82 provided at components adapted to be coupled to the connector core 23. In certain examples, the interior and exterior coupling arrangements can include threaded configurations, bayonet-style configurations, and other interlock configurations. The interlock configurations can include configurations that interlock by snap-fit actions and configurations having stops that are rotated from non-overlapped positions to overlapped positions in which interference between the stops provide for axial retention of the turn-to-secure coupler 26. As depicted, the coupling arrangement 27 has a quarter-turn interlock of the type disclosed by PCT International Publication No. WO2021/041305, which is hereby incorporated by reference in its entirety.

The front plug end 52 of the connector core 23 has a form factor compatible with the fiber optic adapter 41, the fiber optic adapter 43 and the small form-factor adapter 38. While the front plug end 52 is compatible with the fiber optic adapters 41, 43, the first and second hardened connector shroud and fastener arrangements 34, 36 are respectively needed to secure and seal the connector core 23 within the fiber optic adapters 41, 43. In contrast, the connector core 23 can be installed directly within the small form-factor adapter 38 without any intermediate shrouds and without requiring any fasteners in addition to the turn-to-secure coupler 26. Specifically, when the connector core 23 is secured within the small form-factor adapter 38, the seal 30 forms a seal with the small form-factor adapter 38 and the turn-to-secure coupler 26 couples directly to a coupling arrangement 82 of the small form fiber optic adapter 38.

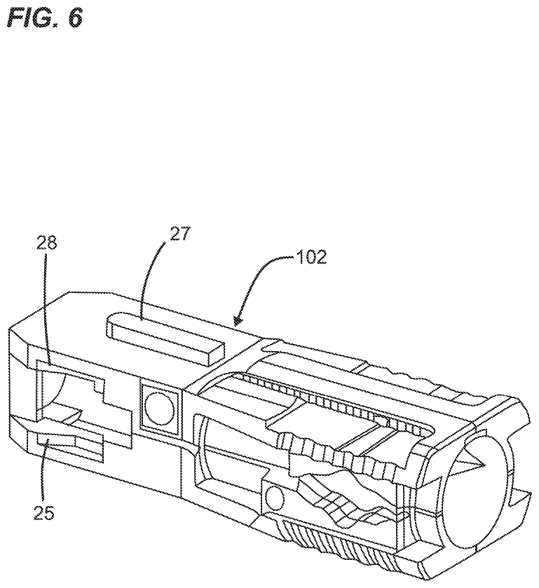

As indicated previously, the front plug end 52 of the connector core 23 has a form factor compatible with a standard, non-hardened SC fiber optic adapter. As depicted, the connector core 23 includes latching shoulders 100 adapted to be engaged by flexible latches of the SC fiber optic adapter to retain the connector core 23 within the SC fiber optic adapter. The connector core 23 can be fitted with an SC release sleeve 102 (see FIG. 6) used for releasing the connector core 23 from the port of the SC fiber optic adapter. The SC release sleeve 102 can be configured to slide axially relative to the connector core 23 and can include ramps 25 for flexing the flexible latches of the SC fiber optic adapter outwardly relative to the connector core 23 when the SC release sleeve is slid rearwardly relative to the connector core 23 to disengage the flexible latches from the latching shoulders 100 such that the connector core 23 can be withdrawn from the SC fiber optic adapter port. The SC release sleeve 102 can include an internal latch for retaining the SC release sleeve on the connector core 23 and for allowing the SC release sleeve 102 to be fitted on the connector core 23 by sliding the SC release sleeve 102 over the front end of the connector core 23 and snapping the SC release sleeve 102 into a retained position relative to the connector core 23 in which the latch is captured between stops of the connector core 23 which limit a range of axial movement of the SC release sleeve 102 relative to the connector core 23. The SC release sleeve 102 can include a key 27 for ensuring insertion of an SC connector into an SC adapter at a predefined rotational orientation.

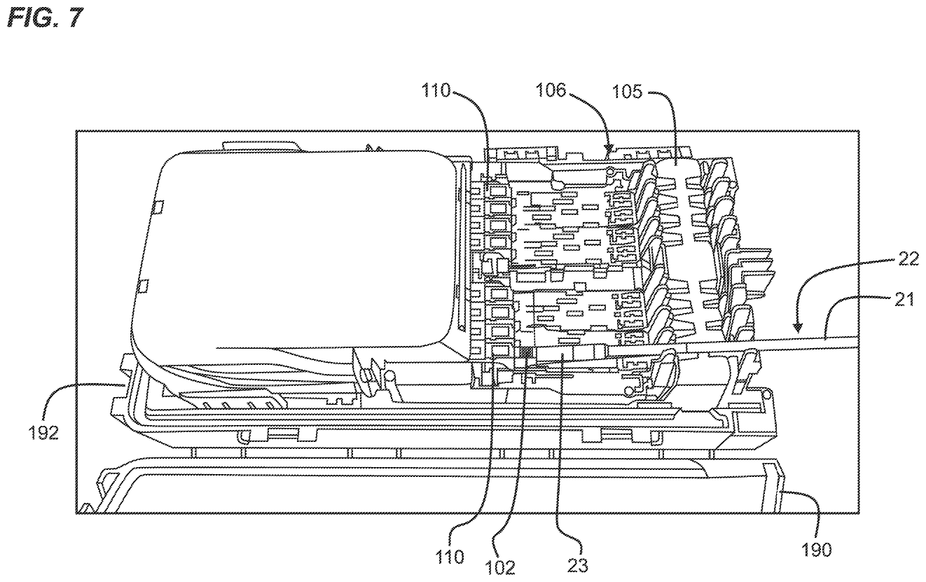

FIG. 7 depicts an enclosure 106 having a plurality of SC fiber optic adapters 110 (e.g., a bank of SC fiber optic adapters) arranged in a row. The SC fiber optic adapters 110 are positioned close to one another to provide higher density. To use the pre-terminated cable 22 for this type of high-density, non-hardened application, it is desirable to not include the turn-to-secure coupler 26 or the strain relief boot 28 on the connector core 23. Not including the turn-to-secure coupler 26 or the strain relief boot 28 as part of the pre-terminated cable 22 reduces the size of the pre-terminated cable 22 thereby rendering it more compatible with non-hardened configurations. Additionally, the reduced size can be advantageous in facilitating passing the pre-terminated cable 22 through a duct. The enclosure 106 can include a sealing arrangement 105 for sealing about the cable 21 at an entry point into the enclosure. The sealing can occur about the cable 21 at a location behind the connector core 23. The enclosure 106 can also be sealed about its perimeter by a sealing member (e.g., a gasket) positioned between a cover 190 and a base 192 of the enclosure 106. The cover 190 and the base 192 can be connected by a hinge that allows the cover 190 and the base 192 to be moved relative to each other between open and closed positions. Latches can be provided for securing the cover 190 and the base 192 in the closed position.

In one example, the pre-terminated cable 22 can be shipped from the factory with the turn-to-secure coupler 26 and the strain relief boot 28 pre-installed on the connector core 23. In the field, if it is desired to use the pre-terminated cable for a hardened application, the pre-installed turn-to-secure coupler 26 and strain relief boot 28 are available for use in connecting the connector core 23 to a hardened component (e.g., a converter or hardened fiber optic adapter). Additionally, the turn-to-secure coupler 26 can retain the dust cap 32 on the connector core 23 during transit. However, by providing the turn-to-secure coupler 26 and the strain relief boot 28 with a removeable construction, the turn-to-secure coupler 26 and the strain relief boot 28 can be removed from the connector core 23 in the field to render the pre-terminated cable 22 more compatible with high-density applications such as non-hardened connection applications.

In another example, the pre-terminated cable 22 can be shipped from the factory with the turn-to-secure coupler 26 and the strain relief boot 28 separate from the connector core 23. In the field, if it is desired to use the pre-terminated cable for a hardened application, the turn-to-secure coupler 26 and strain relief boot 28 can be installed in the field on the connector core 23. Otherwise, the connector core 23 is ready for use for non-hardened applications.

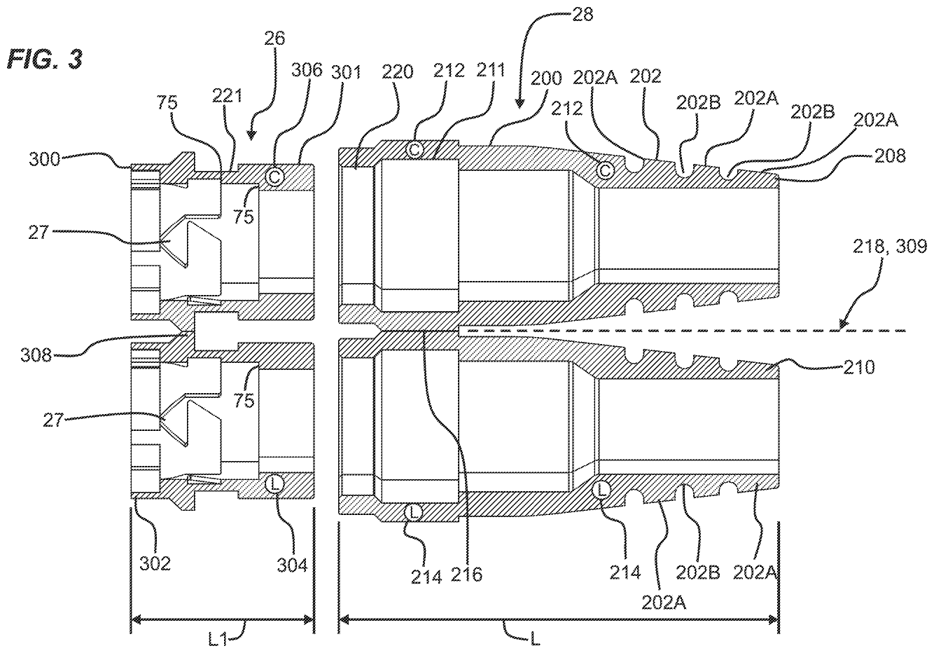

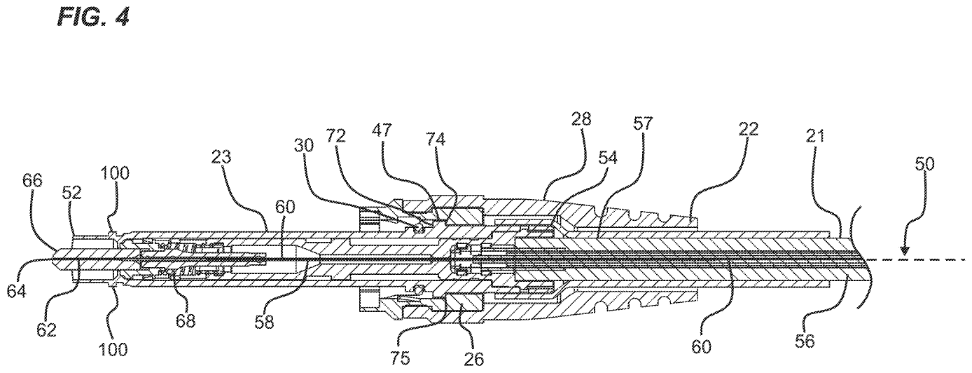

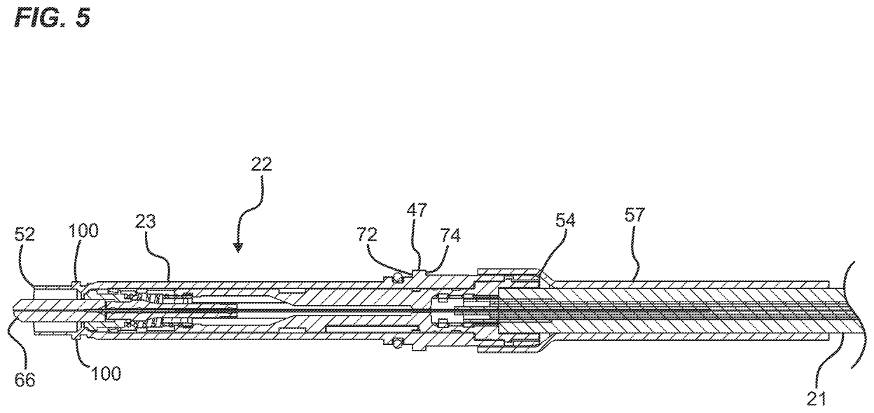

FIG. 3 depicts a configuration of the strain relief boot 28 which allows the strain relief boot 28 to be: a) mounted over the connector core 23 after the connector core 23 has been affixed at the end of the fiber optic cable 21; and/or b) removed from the connector core 23 after the connector core 23 has been affixed at the end of the fiber optic cable 21. The strain relief boot 28 has a front main body portion 200 adapted to fit over the connector core 23 and a rear bend protection 202 adapted to fit over the fiber optic cable 21. The rear bend protection portion 202 has an exterior taper that reduces in size as the rear bend protection portion extends in a rearward direction from the front main body portion 200. The rear bend protection portion 202 is depicted having a segmented configuration. The segmented configuration is depicted including first circumferential segments 202a separated by second circumferential segments 202b, the first circumferential segments 202a having greater radial wall thicknesses than the second circumferential segments 202b. The second circumferential sections 202b can correspond to exterior notches 203 in the strain relief boot 28, and the first circumferential segments 202a can have gradually reduced radial wall thicknesses as the strain relief boot 28 extends in a rearward direction.

The strain relief boot 28 can have a molded plastic or rubber construction and is preferably made of suitable a polymeric material. The turn-to-secure coupler 26 can have a molded plastic construction; but is preferably molded of a plastic material that is harder than the material that forms the strain-relief boot 28.

The strain relief boot 28 has a length L that extends along a central longitudinal axis 206. The strain relief boot 28 includes first and second parts 208, 210 that can be moved apart from one another to allow the strain relief boot 28 to be installed on the pre-terminated cable 22 or removed from the pre-terminated cable 22. The first and second parts 208, 210 are depicted each extending fully along the length L of the strain relief boot 28 and each define a portion of the front main body portion 200 and a portion of the rear bend protection portion 202. As depicted the first and second parts 208, 210 are half-parts.

The first and second parts 208, 210 can be configured to latch together. For example, the first part 208 can include catches 212 that engage with latches 214 of the second part 210 to secure the first and second parts 208, 210 together by a snap-fit connection. The first and second parts 208, 210 include longitudinal edges connected by a hinge 216 having a hinge axis 218 that extends along a central longitudinal axis of the strain relief boot. The first and second parts 208, 210 are moveable relative to one another about the hinge axis 218 between an open position and a closed position. As depicted, the hinge 216 is a living hinge. The strain relief boot 28 can be installed on the pre-terminated cable 22 (i.e., over the connector core 23) by moving the strain relief boot 28 to the open position, inserting the strain relief boot 28 over the turn-to-secure coupler which has already been installed on the pre-terminated cable 22, and then closing and latching the strain relief boot about the turn-to-secure coupler 26 such that the strain relief boot 28 interlocks with an exterior of the turn-to-secure coupler 26 to resist axial movement of the strain relief boot 28 relative to the turn-to-secure coupler 26. In one example, an inner projection 220 (e.g., an annular end ring) of the strain relief boot 28 fits within an outer receptacle (e.g., an annular groove 221) of the turn-to-secure coupler 26 to provide the interlock. A projection 301 of the coupler 26 can also fit within a receptacle 211 of the boot 28 to provide another interlock for vertically axial mount of the boot 28 to the coupler 26. The strain relief boot 28 can be unlatched and opened to remove the strain relief boot from the turn-to-secure coupler 26.

FIG. 3 also depicts a configuration of the turn-to-secure coupler 26 which allows the turn-to-secure coupler 26 to be: a) mounted over the connector core 23 after the connector core 23 has been affixed at the end of the fiber optic cable 21; and/or b) removed from the connector core 23 after the connector core 23 has been affixed at the end of the fiber optic cable 21.

In one example, the turn-to-secure coupler 26 includes first and second parts 300, 302 that can be moved apart from one another to allow the turn-to-secure coupler 26 to be installed on the pre-terminated cable 22 or removed from the pre-terminated cable 22. The first and second parts 300, 302 each extend fully along an axial length L1 of turn-to-secure coupler 26. The axial length L1 extends along an axis of rotation of the turn-to-secure coupler 26 about which the turn-to-secure coupler 26 can turn relative to the connector core 23 to secure the connector core 23 to a fiber optic adapter, a converter, or a dust cap (e.g., of the type described above). The first and second parts 300, 302 are depicted as half-pieces of the turn-to-secure coupler 26. The first and second parts 300, 302 are depicted as being configured to latch together (e.g., can include a latch 304 adapted to engage a catch 306). The first and second parts 300, 302 are depicted including axially extending edges connected by a hinge 308 having a hinge axis 309 that extends along the axis of rotation of the turn-to-secure coupler 26. The first and second parts 300, 302 are depicted as being moveable relative to one another about the hinge axis between an open position and a closed position. In the depicted example, the hinge 308 is a living hinge. The coupler 26 can be installed on the pre-terminated cable 22 (i.e., over the connector core 23) by moving the coupler 26 to the open position, inserting the coupler 26 over the connector core 23 which has already been installed on the pre-terminated cable 22, and then closing and latching the coupler 26 about the connector core 23 such that the coupler 26 opposes a feature on the exterior of the core housing 24 to resist axial movement of the coupler 26 at least in a forward direction relative to the connector core 23. In one example, upon assembly of the coupler 26 on the core housing 24, the forwardly facing stop surface 75 of the coupler 26 opposes the rearwardly facing surface 74 of the stop 47 on the core housing to limit forward movement of the coupler 26 relative to the connector core 23. Interference with a shape-memory sleeve (e.g., sleeve 57) at the rear of the connector core 23 can limit rearward axial movement of the coupler 26 relative to the connector core 23 when the coupler 26 is installed on the connector core 23. The coupler 26 can be unlatched and opened to remove the coupler 26 from the connector core 23.

In other examples, the turn-to-secure coupler 26 and/or the strain relief boot 28 can each have a one-piece configuration and can be configured to slide rearwardly over the front end of the pre-terminated cable 22 and snapped in place with respect to the connector core. In such examples, the turn-to-secure coupler 26 and/or the strain relief boot 28 can include one or more internal flexible latches for engaging a corresponding structure on the exterior of the connector core 23 to provide an interlock between the components. In one example, the turn-to-secure coupler can have an internal latch, and during assembly on the pre-terminated cable the strain relief boot can first be inserted rearwardly onto the pre-terminated cable 22, the turn-to-secure coupler 26 can be slid rearwardly onto the pre-terminated cable 22 and latched onto the connector core 23, and then the strain relief boot 28 can be slid forwardly onto the turn-to-secure coupler 26. Alternatively, the turn-to-secure coupler 26 and the strain relief boot 28 can be pre-assembled together and slid rearwardly onto the pre-terminated cable 22 until a latch associated with the turn-to-secure coupler 26 or the strain relief boot 28 interlocks with the connector body 23.

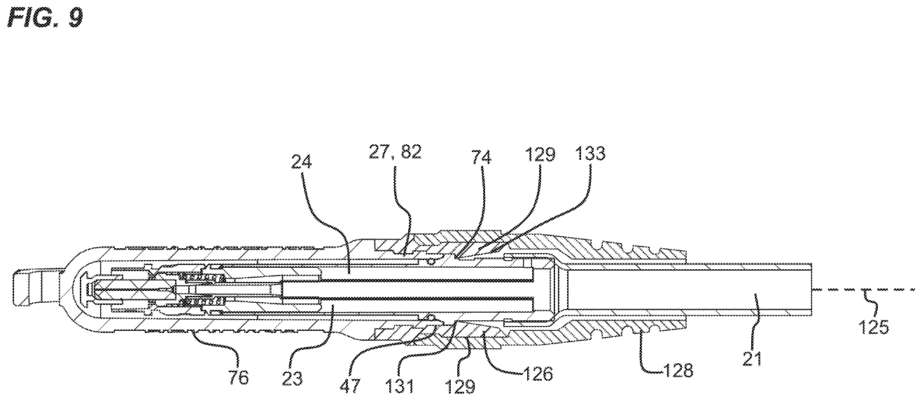

FIG. 9 depicts an example coupler 126 and boot 128 having a configuration that is an example of the type discussed above in which the coupler 126 includes one or more internal latches 129 (e.g., a pair of resilient cantilever style latches disposed at opposite sides of a central axis 125 of the coupler 126) that are adapted to engage the rearwardly facing stop surface 74 of the stop 47 of the core housing 24. The latches 129 can have catch/stop surfaces 131 for engaging the stop surface 74 and can also include ramp surfaces 133. During insertion in a rearward direction of the coupler 126 over the connector core 123, the ramp surfaces 133 contact the stop 47 causing the latches 129 to flex radially outwardly thereby allowing the stop surfaces 131 to move rearwardly past the stop surface 74 and then snap-back radially inwardly (e.g., caused by the inherent resiliency/elasticity of the latches 129) to a retention position in which the stop surfaces 131 oppose the rearwardly facing stop surfaces 74 of the stop 47. In certain examples, the coupler 126 and boot 128 can each having a molded construction. In certain examples, the coupler 126 has a molded plastic construction and the strain relief boot 128 has a molded plastic or rubber construction. In certain examples, the strain relief boot 128 is softer, or more resilient, or more flexible than the coupler 126. In certain examples, the strain relief boot 128 has an internal passage large enough to allow the strain relief boot 128 to be passed over the connector core 23 in a rearward direction, or the strain relief boot 128 is sufficiently deformable to allow the strain relief boot 128 to resiliently deform (e.g., by stretching or expanding) to allow passage of the strain relief boot 128 over the connector core 23. In certain examples, the latches 129 can be flexed from the retaining position radially outwardly to a release position (e.g., either manually or through the use of a tool) to allow for removal of the coupler 126 from the connector core 23 by sliding the coupler 126 in a forward direction off the connector core 23. The boot 128 can have the same or a similar profile as the boot 28. The coupler 126 and the boot can be mounted on the connector core 23 after affixation of the connector core 23 at the end of the fiber optic cable 21.

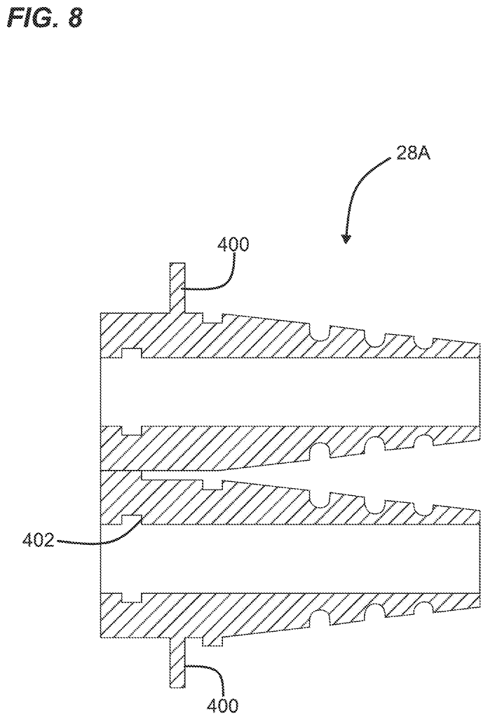

The system 20 can also include a reduced-size strain relief boot 28a (see FIG. 8) that is smaller than the strain relief boot 28. The reduced-size strain relief boot 28a can be mounted on the connector core 23 when the connector core 23 is being used for non-hardened applications. The reduced-size strain relief boot 28a can have the same type of configuration as the strain relief boot 28 for allowing the reduced-size strain relief boot 28a to be: a) mounted over the connector core 23 after the connector core 23 has been affixed at the end of the fiber optic cable 21; and/or b) removable from the connector core 23 after the connector core 23 has been affixed at the end of the fiber optic cable 21. The reduced-size boot 28a can also include an axial fixing interface (e.g., a projection or receptacle) for engaging with an axial fixing interface (e.g., a projection or receptacle) of the enclosure to axially fix the connector core 23 relative to the enclosure. In one example, the boot can include an axial fixing interface such as a flange 400 or other projection that fits within an axial fixing interface of the enclosure such as a slot or other receptacle. The strain relief boot 28a can have an internal feature, (e.g., a ring, flange, notch, groove, etc.) adapted to interlock with a mating feature of the connector core 23 to axially fix the strain relief boot 28a relative to the connector core 23 when the strain relief boot 28a is mounted on the connector core 23. For example, the strain relieve boot 28a can include an internal groove 402 for receiving the stop 47 defined at the exterior of the connector core 23.

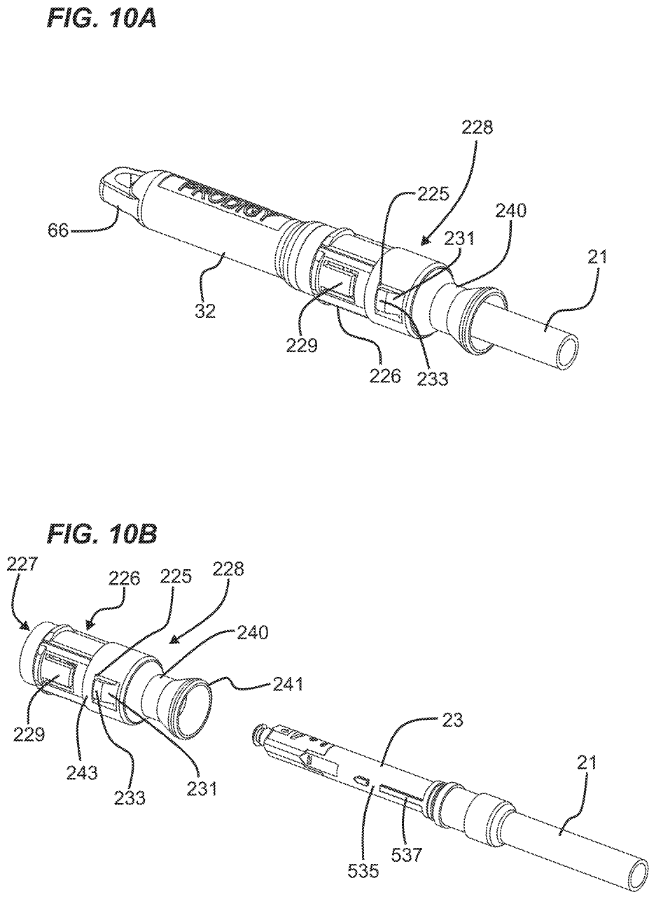

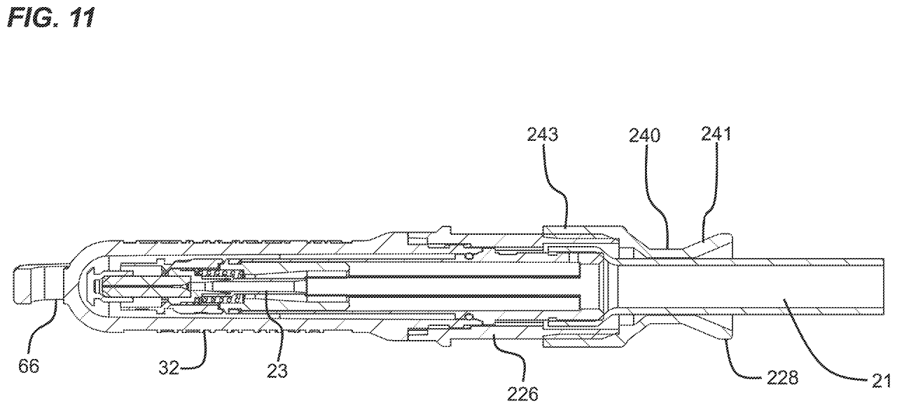

FIGS. 10A, 10B, and 11 depict an alternative example of a coupler/boot assembly 227 including a coupler 226 (e.g., a snap-on coupler adapted to be snapped onto a connector core) and a boot 228 (e.g., a snap-on boot adapted to be snapped onto the coupler 226). The coupler 226 and the boot 228 can be latched together prior to installation on the connector core 23. The coupler 226 may have at least one latch 229 (e.g., a pair of latches on opposite sides of the coupler 226) integrated with a main body of the coupler 226 for latching the coupler 226 onto the connector core 23. In one example, when the coupler 126 is latched on the connector core 23, the latch 229 is adapted to engage/oppose the rearwardly facing surface 74 of the stop 47 on the exterior of the connector core 23 to retain the coupler 126 on the connector core 23 by limiting forward movement of the coupler 126 relative to the connector core 23. The coupler 126 can include an interior stop (e.g., an inner shoulder) configured to oppose a forward end of a heat shrink mounted at the rear of the connector core 23 to limit rearward movement of the coupler 126 relative to the connector core 23. The boot 228 may have at least one opening 225 (e.g., a pair of openings positioned on opposite side of the boot 228) configured to receive a catch 233 (e.g., a pair of oppositely positioned catches) integrated with an exterior of the main body of the coupler 226. In one example, the catch 233 snaps into place within the opening 225 as the boot 228 is inserted forwardly over a rear end of the coupler 226 to secure the boot 228 over the rear end of the coupler 226. The catch 233 can include a ramp 231 that facilitates insertion of the catch 233 into the opening 229. When the coupler 226 and boot 228 are assembled together and installed on the connector core 23, the coupler 226 and the boot 228 can be rotated together relative to the connector core 23 about a central axis of the connector core 23. With the coupler/boot assembly 227 installed on the connector core 23, the coupler 226 is adapted for use in coupling the connector core 23 to another structure such as a fiber optic adapter, a converter, another connector or a dust cap; and the boot 228 is adapted to provide bend radius protection to the cable 21. As depicted the coupler 228 is a turn-to-secure coupler shown securing the dust cap 32 over the front end of the connector core 23.

The boot 228 of the coupler/boot assembly 227 may have an enlarged front end 243 sized to receive the coupler 226. The rear end of the boot 228 may have a flared end 241 that is configured to provide strain relief to the cable. Between the enlarged front end 243 and the flared end 241 is a constricted portion 240. The constricted portion 240 is sized to fit closely about the cable but allows enough room for the boot 228 to rotate with the coupler 226.

The assembled coupler/boot assembly 227 can be installed on the connector core 23 by pushing the assembly 227 rearwardly over the front end of the connector core 23 until the coupler 226 snaps into a latched position on the connector core adjacent the rear end of the connector core 23. In certain examples, the coupler 226 and boot 228 can each have a molded construction. In certain examples, the coupler 226 has a molded plastic construction and the boot 228 has a molded plastic or rubber construction. In certain examples, the boot 228 is softer, or more resilient, or more flexible than the coupler 226 for providing bend protection to the cable; while the coupler 226 is rigid enough to include an interlock interface suitable for allowing fixation of the connector core to another structure (e.g., the dust cap 32 as depicted). In certain examples, the boot 228 has an internal passage large enough to allow the boot 228 to be passed over the connector core 23 in a rearward direction, or the boot 228 is sufficiently deformable to allow the boot 228 to resiliently deform (e.g., by stretching or expanding) to allow passage of the boot 228 over the connector core 23 and close the gap between the boot 228 and the pre-terminated cable 21. The assembled coupler/boot assembly 227 can be installed directly on the connector core 23 without an intermediate structure (e.g., a housing of an interface converter) between the connector core 23 and the coupler/boot assembly 227.

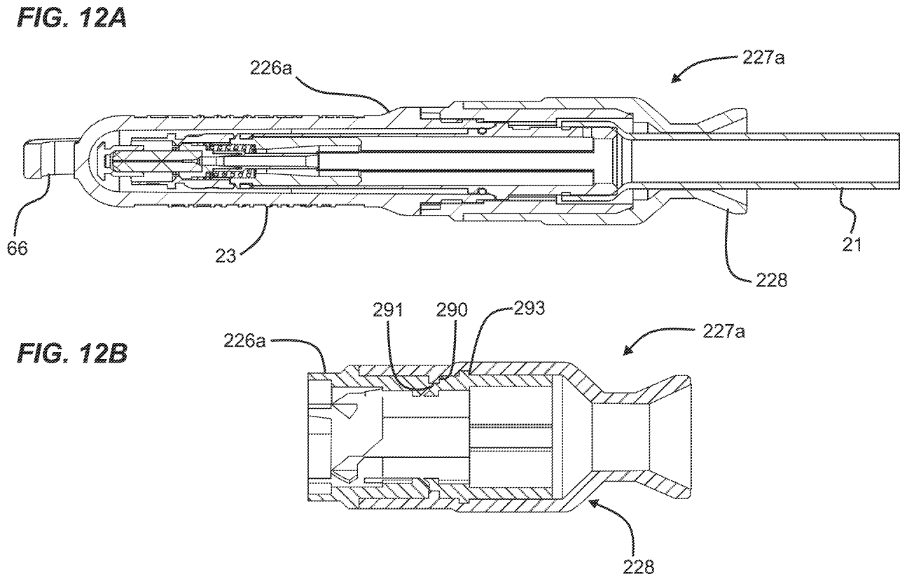

FIGS. 12A and 12B depict an alternative coupler/boot assembly 227a having the same basic configuration as the coupler/boot assembly 227 except an alternative attachment technique has been used to secure the boot and coupler together. For example, the coupler/boot assembly 227a includes a boot 228a that is overmolded over a rear end of a coupler 226a to secure the boot 228a to the coupler 226a. During the overmolding process, the material of the boot 228a can flow into a recess 291 at the exterior of the coupler 226a such that upon curing/hardening of the boot 228a the coupler/boot assembly 227a is interlocked together (e.g., a retention portion 290 of the boot 228a is positioned within the recess 291) to prevent axial movement between the boot 228a and the coupler 226a. Similarly, during the overmolding process, the material of the boot 228a can flow around a stop 293 (e.g., an outer shoulder, projections, etc.) at the exterior of the coupler 226a such that upon curing/hardening of the boot 228a the coupler/boot assembly 227a is interlocked together (e.g., the stop 293 is embedded in the boot 228a to prevent axial movement between the boot 228a and the coupler 226a. In certain examples, the boot 228a can bond to the exterior of the coupler 226a during the overmolding process.

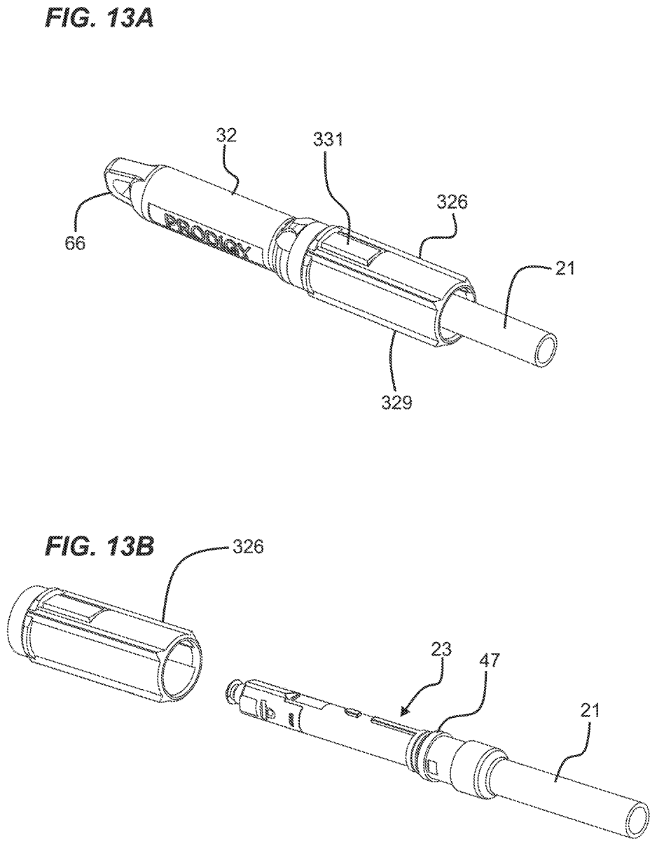

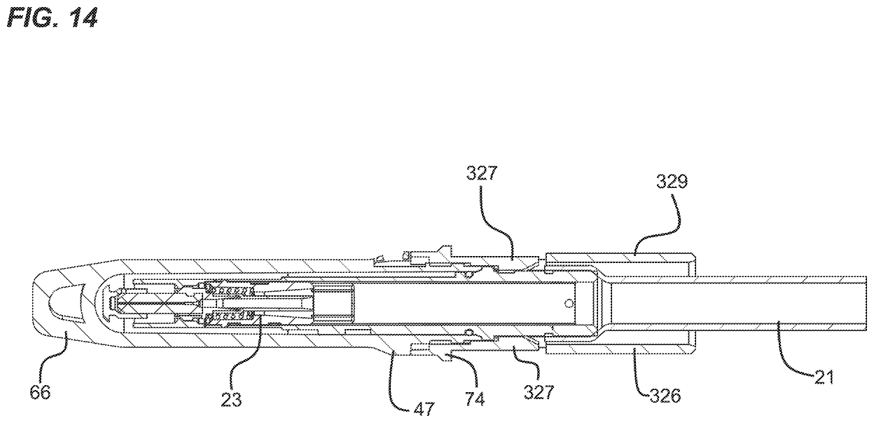

FIGS. 13A, 13B, and 14 depict a one-piece push on coupler 326 adapted to be installed over the connector core 23 of the pre-terminated cable 22. The one-piece push on coupler 326 can have a retention feature such as one or more latches 331 (e.g., oppositely positioned resilient cantilever style latches) adapted to interlock with a corresponding feature (e.g., the stop 47) of the connector core 23 when the one-piece push on coupler 326 is mounted over the connector core 23 to provide axial retention of the coupler 326 on the connector core 23 while allowing the coupler 326 to rotate about the connector core 23.

The one-piece push on coupler 326 may have a rear extension 329, as best seen in FIG. 14. The rear extension 329 extends rearwardly beyond the rear end of the core housing of the connector core 23 and over the cable 21 to which the connector core 23 is affixed. The coupler 326 can include an inner edge, shoulder, stop or other structure that opposes a front end of a heat shrink sleeve installed over the rear end of the core housing and the cable 21 to limit rearward movement of the coupler 326 relative to the connector core 23. A central opening/passage of the one-piece push on coupler 326 may be larger on the side of the cable 21, to allow an amount of bending of the cable 21.

In one embodiment, the one-piece push on coupler 326 can mount directly on the connector core 23 without an intermediary or converter being used.

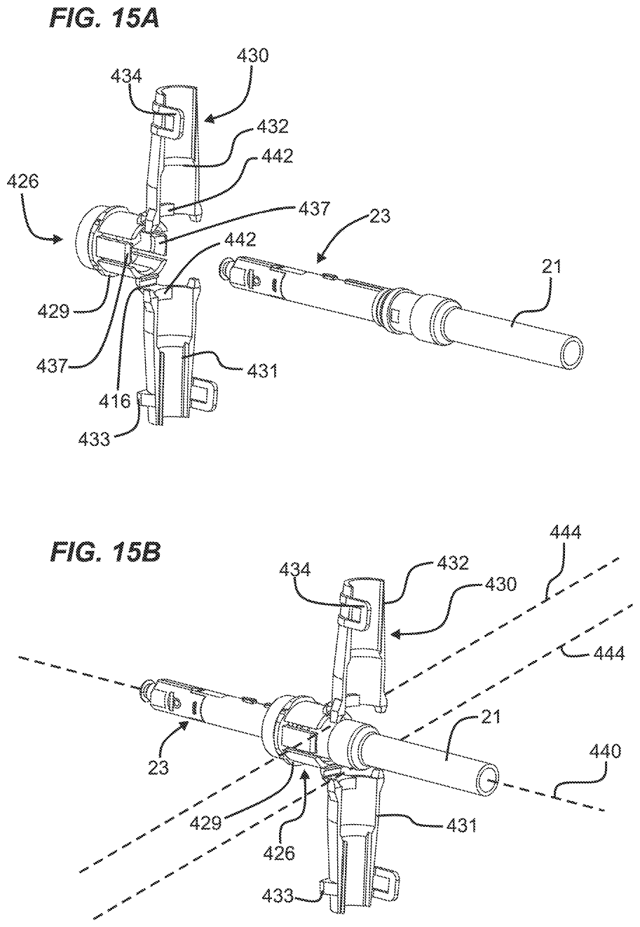

FIGS. 15A, and 15B depict another coupler 426 in accordance with the principles of the present disclosure. The coupler 426 has integrated cable protection adapted to extend over the cable 21 when the coupler 426 is mounted on the connector core 21. The coupler 26 may have a front extension 429, and a rear extension 430. The front extension 429 (e.g., a rotatable coupling portion) can be configured to provide a turn-to-engage coupling function for coupling the connector core 23 to another structure such as a dust cap, fiber optic adapter, converter or other connector. The rear extension 430 is adapted to extend over the cable 21 to provide cable protection and can also include an integrated inner feature adapted to limit rearward movement of the coupler 426 relative to the connector core 23 when the coupler 426 is installed on the connector core 23. The front extension 429 has at least one integral latch 437 (e.g., a pair of oppositely positioned, resilient, axially extending cantilever latches) that snaps the front extension 429 into place with respect to the connector core 23 when pushed over the connector core 23 in a direction extending from the front end 52 toward the rear end 54 of the connector core 23. In one example, similar to previously described examples, the latch 437 can be adapted to engage the stop 47 of the connector core 23.

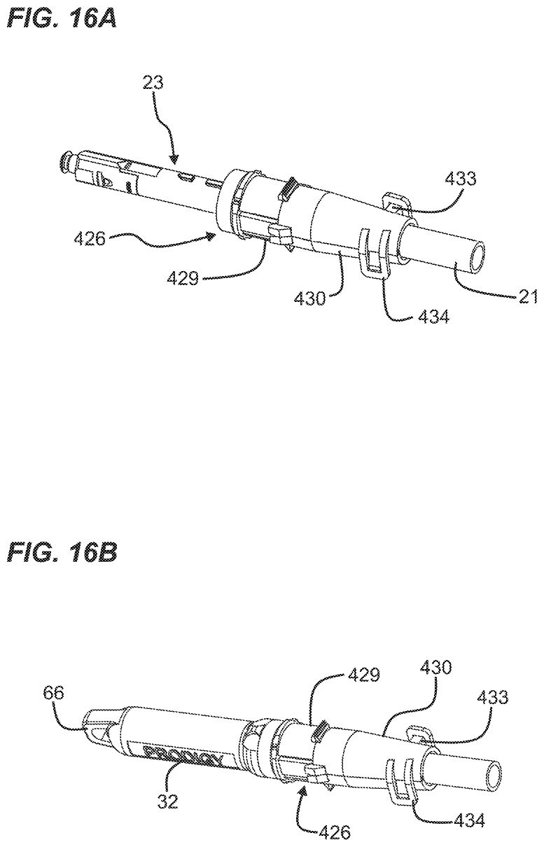

The rear extension 430 is attached to a rear end of the front extension 429. The rear extension 430 has a two-piece configuration (e.g., a first piece 431 and a second piece 432)), each of the two pieces (431, 432) being affixed to the front extension 429 by a hinge (416, 417). The hinges (416, 417) allow the two pieces (431, 432), to move relative to the front extension 429 between an open position (see FIGS. 15A and 15B) and a closed position (see FIGS. 16A and 16B). The hinge (416, 417) locations are at an intermediate location along a length of the coupler 426 and define hinge axes 444 that are transverse relative to the axis orientation of the connector core 23 (i.e., the orientation defined by a central axis 440 which coincides with a central axis of the coupler 426 when the coupler 426 is mounted on the connector core 23) for allowing the rear extension 430 to be moved between the open and closed positions. Each of the two pieces (431, 432) has a latch 434, and a catch 433.

The pieces 431, 432 each include an internal stop 442 adapted to oppose a feature on the connector core 23 (e.g., a front edge of a heat shrink sleeve 57) to limit rearward movement of the coupler 426 relative to the connector core 23. When the rear extension 430 is in the open position, the coupler 426 can be inserted in a rearward direction over the front end of the pre-terminated cable 22 and latched onto the connector core 23 by the latches 437. Once the latches 437 have engaged the stop 47 of the connector core 23, the rear extension 430 is moved to the closed position in which the stops 442 oppose the front end of the heat shrink sleeve 57 and the pieces 431, 432 cover a length of the cable 21. The latches 434 and catches 433 interlock to couple the first and second pieces 431, 432 together and to retain the rear extension 430 in the closed position.

The pivot axes 444 of the two pieces (431, 432) are transverse relative to the central axis 440 of the connectorized cable assembly. The two pieces (431, 432) of the rear extension 430 may be adapted to extend across and protect the location where the pre-terminated cable 22 coupled to the connector core 23. In the open position, the two pieces (431, 432) of the rear extension 430 extend away from the central axis 440 of the connectorized cable assembly. The open position of the rear extension 430 allows the coupler with integrated able protection 430 to be installed or taken off of the connectorized cable assembly. In a closed position, the two pieces (431, 432) of the rear extension 430 pivot towards the central axis 440 of the connectorized cable assembly about the pivot axes 444 of the hinges (416, 417). Once the two pieces (431, 432) run parallel to the central axis of the connectorized cable assembly, the latch 434 on each of the two pieces (431, 432) may latch over the catch 433 to close the two pieces (431, 432) of the rear extension 430, over the portion of the connector core 23 where the cable 21 connects, and partially extending over the cable 21. The rear extension 430 may provide bend protection to the cable 21. In one example, the hinges (416, 417) may each be a living hinge.

In embodiments, the coupler 426 may be mounted on the connector core 23 either after cable termination or removed after cable termination. Additionally, the front extension 429 may be configured to be coupled to a dust cap 32 to protect the connector core 23 of the connectorized cable assembly.

In one example, the front extension 429 and the rear extension 430 may be made out of the same material. In other examples, the front extension 429 may be made of a more rigid material, whereas the rear portion 430 may be made out of a more flexible material to allow additional bend and to accommodate the pre-terminated cable 21.

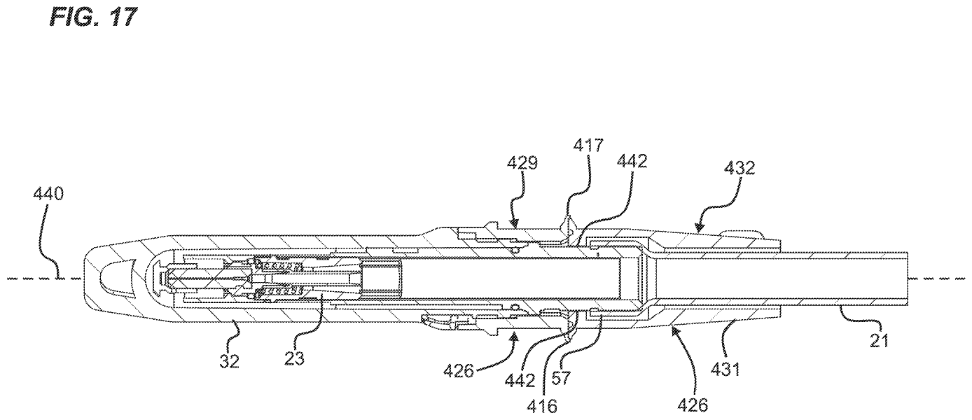

FIGS. 16A, 16B, and 17 depict the coupler 426 of FIGS. 15A and 15B once the coupler 426 has been installed on the connector core 23 by snapping the front extension 429 into place on the connector core 23. During installation of the coupler 426, the two pieces (431, 432) of the rear extension 430 are pivoted about the axes 444 of the hinges (416, 417) towards the central axis 440 of the connectorized cable assembly, until the two pieces (416, 417) are parallel and flush with the connectorized cable assembly. Once the two pieces (431, 432) are flush with the pre-terminated cable 21, the latch 434 on each of the two pieces (431, 432), is pushed down over the catch 433 to engage the latch 434 with the catch 433 and close the two pieces (431, 432) around a portion of the cable 21.

The latch mechanism of the rear end 430 of the coupler 426 is reversible, and the latch 434 may be uncoupled from the catch 433 to release the two pieces (431, 432), at any given time. As seen in FIG. 17, a cross-section of the assembly for the coupler 426 installed over the connectorized cable assembly, a dust cap 32 may connect to the front extension 429 of the coupler 426.

The rear extension 430 may in certain examples act in a similar fashion to the boot mechanisms described herein, to provide strain relief to the pre-terminated cable 21 of the connectorized cable assembly, while still ensuring for an amount of bending to be possible.

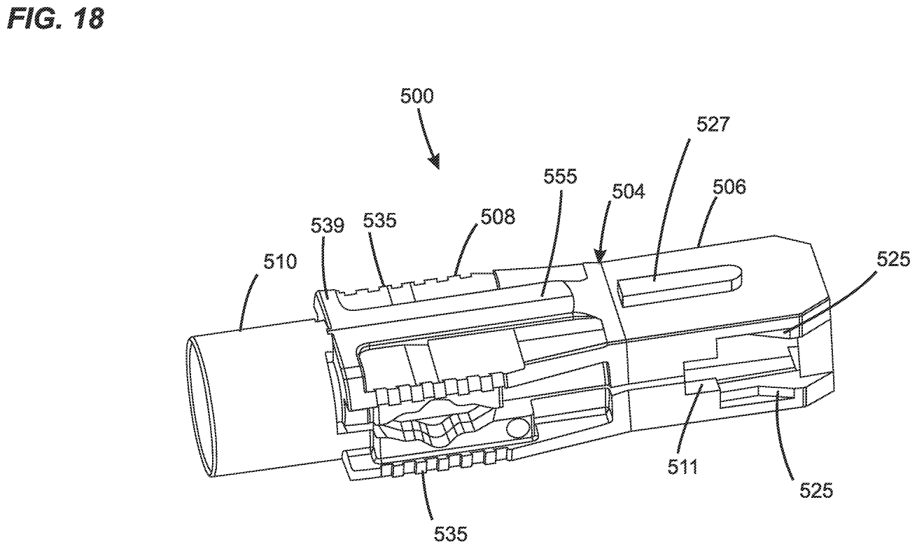

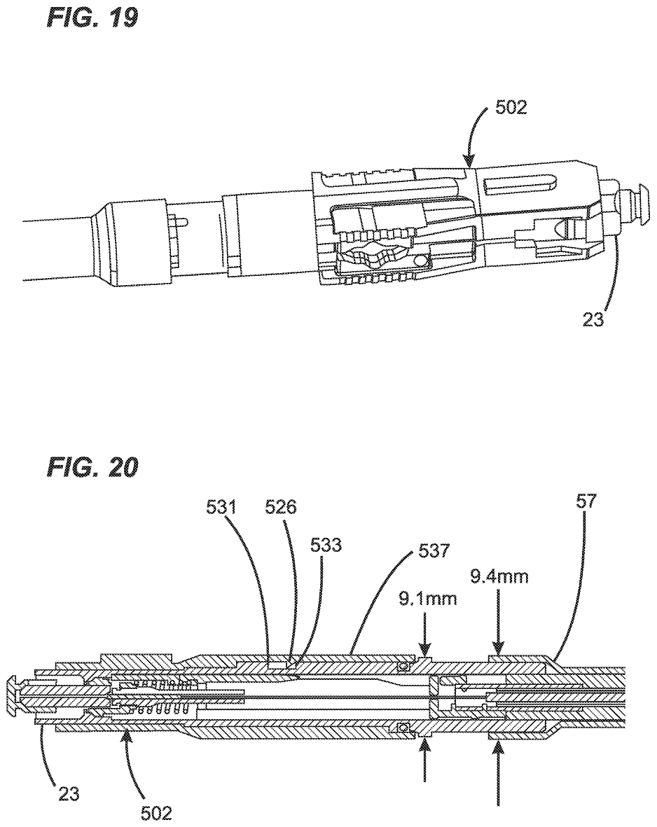

FIG. 18 depicts an alternative SC release sleeve 502 in accordance with the principles of the present disclosure. The SC release sleeve 502 is configured to mount over the connector core 23 adjacent the front plug end 52 to convert the connector core 23 into an SC fiber optic connector adapted to be inserted into and removed from an SC fiber optic adapter. When mounted on the connector core 23, the SC release sleeve 502 is axially slidable relative to the connector core 23 and can be slid rearwardly relative to the connector core 23 to release the connector core 23 from the port of the SC fiber optic adapter. FIGS. 19 and 20 show the SC release sleeve 502 mounted over the connector core 23.

The release sleeve 502 includes a sleeve body 504 having a front portion 506, a middle portion 508 and a rear portion 510. The front portion 506 forms a plug portion sized and shaped to be received in the port of an SC fiber optic adapter. The front portion 506 has a rectangular cross-sectional profile and defines side openings 511 that align with the latching shoulders 100 of the connector core 23 when the release sleeve 502 is mounted on the connector core 23. The front portion 506 can define ramps 525 adjacent the side openings 511. The SC release sleeve 502 can be configured to slide axially relative to the connector core 23 and the ramps 525 are configured for flexing flexible latches of the SC fiber optic adapter outwardly relative to the connector core 23 when the SC release sleeve is slid rearwardly relative to the connector core 23 to disengage the flexible latches from the latching shoulders 100 such that the connector core 23 can be withdrawn from an SC fiber optic adapter port. The SC release sleeve 502 can include an internal latch 526 (see FIG. 20) for retaining the SC release sleeve on the connector core 23 and for allowing the SC release sleeve 502 to be fitted on the connector core 23 by sliding the SC release sleeve 502 over the front end of the connector core 23 and snapping the SC release sleeve 502 into a retained position relative to the connector core 23 in which the latch 526 is captured between stops 531, 533 of the connector core 23 which limit a range of axial movement of the SC release sleeve 502 relative to the connector core 23. The stops 531, 533 can define the ends of a gap or notch 535 provided in a keying rail 537 (see FIG. 10B) of the core housing of the connector core 23. The SC release sleeve 502 can include a key 527 at a top of the front portion 506 for ensuring insertion of an SC connector into an SC fiber optic adapter at a predefined rotational orientation. The key 527 can be configured to fit within a corresponding slot defined by the SC fiber optic adapter.

The middle portion 508 of the release sleeve 502 has an enlarged cross-sectional profile as compared to the front and rear portions 506, 510. The middle portion 508 can include a rectangular cross-sectional profile and can be configured to facilitate gripping of the release sleeve 502. Gripping projections 535 can be provided on the middle portion 508 along edges of the middle portion 508. The middle portion 508 of the release sleeve 502 can include a central longitudinal rib 555 that aligns with the key 527. A rear end of the middle portion 508 includes and is defined by an outer flange 539 that is transversely oriented relative to a central axis of the release sleeve 502. The outer flange 539 can extend around the rectangular outer cross-sectional profile of the middle portion 508.

The rear portion 510 of the release sleeve 502 extends rearwardly from the rear end of the middle portion 508 and can have a cylindrical outer cross-sectional shape. The rear portion 510 forms a sleeve that covers a portion of the connector core 23 behind the gripping portion of the release sleeve 502. In certain examples, the rear portion 510 can be sized to cover the seal 30 of the connector core 23 at least when the release sleeve 502 is in a retracted state relative to the connector core 23.

In certain examples, the connector core 23 with the release sleeve 502 mounted thereon can be used as an SC connector and can be used in the field without a strain relief boot at the connector to cable interface. For example, to minimize size, the cable assembly with the connector core 23 and the release sleeve 502 can not include a strain relief boot. Instead, the heat shrink sleeve 57 can be exposed in the final product. In certain examples, the heat shrink sleeve 57 and the connector core housing 24 can have the same or a similar color. In certain examples, the connector core housing 24 can have a light transmissive construction (e.g., transparent, translucent, etc.) and adhesive used within the connector core housing to anchor the cable to the connector core 23 can occupy the rear cable attachment end 54 and can have a dark color (e.g., black) selected to match or generally match the color of the heat shrink sleeve 57 to enhance the overall aesthetic appearance of the cable assembly.

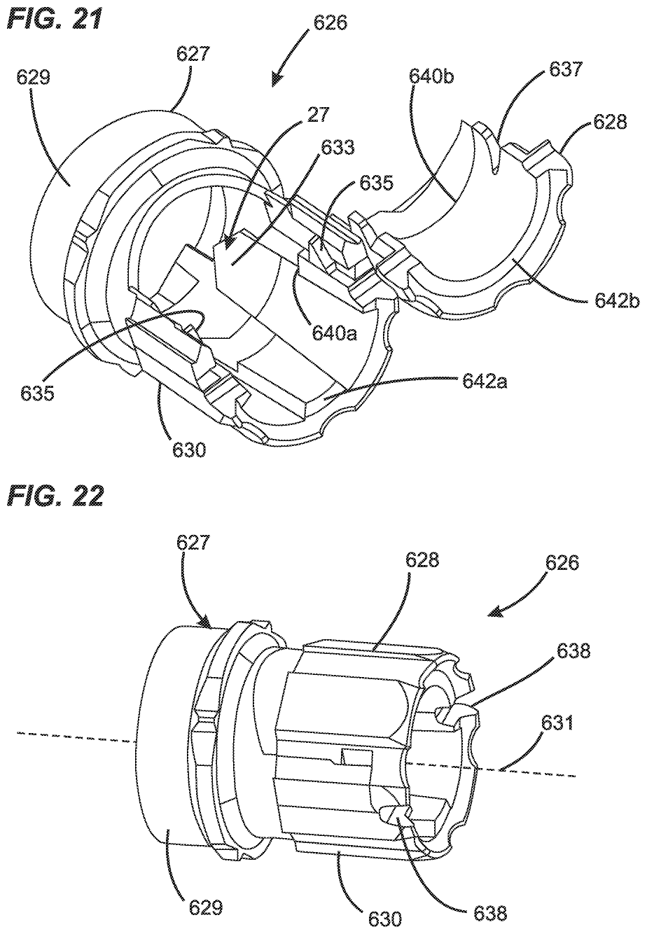

FIGS. 21 and 22 depict an alternative turn-to-secure coupler 626 having a further configuration which allows the turn-to-secure coupler 626 to be: a) mounted over the connector core 23 after the connector core 23 has been affixed at the end of the fiber optic cable 21; and/or b) removed from the connector core 23 after the connector core 23 has been affixed at the end of the fiber optic cable 21. The turn-to-secure coupler 626 includes a main coupler body 627 and a side cover 628. The main coupler body 627 includes a front portion 629 and a rear extension 630. In the depicted example, the rear extension 630 and the front portion 629 are connected by a unitary connection such that the main coupler body has a one-piece unitary construction. The main coupler body 627 and the side cover 628 can be molded plastic parts.

The front portion 629 of the main coupler body 627 fully circumferentially surrounds a central longitudinal axis 631 of the turn-to-secure coupler 626. In use, the turn-to secure coupler 626 is turned about the axis 631 to make a coupling or to release a coupling. The interior coupling arrangement 27, which is adapted to couple with the mating exterior coupling arrangement 82 provided at components adapted to be coupled to the connector core 23, is defined within an interior of the front portion 629 of the main coupler body 627. The interior coupling arrangement 27 includes coupling projections 633 positioned circumferentially about the central longitudinal axis 631. The rear extension 630 and the side cover 628 are each constructed to only partially circumferentially surround the central longitudinal axis 631. The side cover 628 is adapted to attach to the rear extension 630 (e.g., by a snap-fit connection). When the side cover 628 is attached to the rear extension 630, the rear extension 630 and the side cover 628 cooperate to fully surround the central longitudinal axis 631. The rear extension 630 can include guides 635 (e.g., triangular guides) that mate with corresponding notches 637 (e.g., triangular notches) defined by the side cover 628 to facilitate and maintain alignment between the side cover 628 and the rear extension 630. The side cover 628 is configured to block a lateral opening (e.g., an open side) of the rear extension 630 when the side cover 628 is mounted to the rear extension 630. The rear extension 630 and the side cover 628 are each configured to extend from a rear of the front portion 629 of the main coupler body 627 to a rear of the turn-to-secure coupler 626. The rear extension 630 and the side cover 628 can define pry notches 638 configured for receiving a tool (e.g., a screwdriver) that can be used to pry the rear extension 630 and the side cover 628 apart to disconnect a coupling (e.g., a snap-fit coupling) between the rear extension 630 and the side cover 628. In certain examples, the side cover 628 can be connected to the rear extension 630 by a hinge (e.g., a living hinge) that allows the side cover 628 to be pivoted relative to the rear extension 630 between an attached configuration (where the side cover 628 is coupled to the rear extension 630 (e.g., by a snap-fit connection) to cover the open side of the rear extension 630) and a detached configuration in which the side cover 628 is displaced from the rear extension 630 such that the open side of the rear extension 630 is uncovered.

The rear extension 630 and the side cover 628 include internal structure providing stops for engaging corresponding structure of the connector core 23 to limit axial movement of the turn-to-secure coupler 626 relative to the connector core 23 when the turn-to-secure coupler is mounted on the connector core 23. When the side cover 628 is detached from the rear extension 630, the main coupler body 627 can be inserted rearwardly over the front of the connector core 23 to move the main coupler body 627 to a mounting position relative to the connector core 23 during installation of the turn-to-secure coupler 626; and can be moved forwardly from the mounting position over the connector core 23 to remove the main coupler body 627 from the connector core 23. The side cover 628 and the rear extension 630 can respectively include forward stops 640a, 640b and rearward stops 642a, 642b configured to limit axial movement of the turn-to-secure coupler 626 relative to the connector core 23 when the turn-to-secure coupler 626 is mounted on the connector core 23. For example, the forward stops 640a, 640b are adapted to oppose the rear surface 74 of the outer stop 47 of the connector core 23 and the rearward stops 642a, 642b are adapted to oppose the forward end of the heat shrink sleeve 57 of the connector core 23. A boot such as boot 28 can be configured to mount over the assembled turn-to-secure coupler 626.

It will be appreciated that any of the couplers disclosed herein can be turn-to-engage couplers (e.g., threaded couplers, bayonet-style couplers, other partial-turn couplers) adapted to interlock with structures such as dust caps, fiber optic adapters, converters or other fiber optic connectors. The couplers can be configured to mount over a connector core from the front end of the connector core after affixation of the connector core at the end of a cable such as a fiber optic cable. In certain examples, the couplers can be removeable from the connector core after affixation (e.g., removeable in the field).

1. A connectorized cable assembly comprising:
a fiber optic cable having an end, the fiber optic cable including a jacket containing at least one optical fiber and at least one strength member;
a connector core affixed at the end of the fiber optic cable, the connector core having a front end and a rear end, the strength member being anchored relative to the connector core at the rear end of the connector core when the connector core is affixed at the end of the fiber optic cable, and the rear end of the connector core being sealed relative to the jacket of the fiber optic cable when the connector core is affixed at the end of the fiber optic cable;
a seal carried by the connector core at an exterior of the connector core;
a ferrule positioned adjacent the front end of the connector core, the ferrule supporting a front end of the optical fiber or supporting an optical fiber stub spliced to the optical fiber; and
a boot configured to be: a) mounted over the connector core after the connector core has been affixed at the end of the fiber optic cable; and/or b) removable from the connector core after the connector core has been affixed at the end of the fiber optic cable; wherein the boot is configured for providing bend protection to the fiber optic cable adjacent the rear end of the connector core, the boot being configured to not provide sealing about the fiber optic cable.

2. The connectorized cable assembly of claim 1, wherein the boot has a front main body portion adapted to fit over the connector core and a rear bend protection adapted to fit over the fiber optic cable, the rear bend protection portion having an exterior taper that reduces in size as the rear bend protection portion extends in a rearward direction from the front main body portion, the rear bend protection portion having a segmented configuration.

3. The connectorized cable assembly of claim 2, wherein the segmented configuration includes first circumferential segments separated by second circumferential segments, the first circumferential segments having greater radial wall thicknesses than the second circumferential segments.

4. The connectorized cable assembly of claim 1, wherein the boot has a length that extends along a central longitudinal axis, wherein the boot includes first and second parts that can be moved apart from one another to allow the boot to be installed on the connectorized cable assembly or removed from the connectorized cable assembly.

5. The connectorized cable assembly of claim 4, wherein the first and second parts each extend fully along the length of the boot and each define a portion of the front main body portion and a portion of the rear bend protection portion.

6. The connectorized cable assembly of claim 5, wherein the first and second parts are configured to latch together.

7. The connectorized cable assembly of claim 6, wherein the first and second parts include longitudinal edges connected by a hinge having a hinge axis that extends along the central longitudinal axis of the boot.

8. The connectorized cable assembly of claim 7, wherein first and second parts are moveable relative to one another about the hinge axis between an open position and a closed position.

9. The connectorized cable assembly of claim 8, wherein the hinge is a living hinge.

10. The connectorized cable assembly of claim 1, wherein the boot includes an anchoring interface for axially fixing the boot and the connector core relative to an enclosure.

11. The connectorized cable assembly of claim 1, further comprising an SC release sleeve configured to mount on the connector core after the connector core has been affixed at the end of the fiber optic cable.

12. The connectorized cable assembly of claim 1, wherein the strength member of the fiber optic cable is anchored to the connector core by adhesive.

13. The connectorized cable assembly of claim claim 1, wherein the jacket of the fiber optic cable is sealed relative to the connector core by a heat shrink sleeve.

14. A connectorized cable assembly comprising:
a fiber optic cable having an end, the fiber optic cable including a jacket containing at least one optical fiber and at least one strength member;
a connector core affixed at the end of the fiber optic cable, the connector core having a front end and a rear end, the strength member being anchored relative to the connector core at the rear end of the connector core when the connector core is affixed at the end of the fiber optic cable, and the rear end of the connector core being sealed relative to the jacket of the fiber optic cable when the connector core is affixed at the end of the fiber optic cable;
a seal carried by the connector core at an exterior of the connector core;
a ferrule positioned adjacent the front end of the connector core, the ferrule supporting a front end of the optical fiber or supporting an optical fiber stub spliced to the optical fiber;
a turn-to-secure coupler for: a) securing the connector core in a fiber optic adapter wherein the seal provides sealing between the connector core and the fiber optic adapter; or b) securing a converter over the connector core wherein the seal provides sealing between the connector core and the converter; or c) securing a dust cap over the front end of the connector core wherein the seal provides sealing between the connector core and the dust cap; and
wherein the turn-to-secure coupler mounts directly over the connector core and is configured to be: a) mounted over the connector core after the connector core has been affixed at the end of the fiber optic cable; and/or b) removable from the connector core after the connector core has been affixed at the end of the fiber optic cable.

15. The connectorized cable assembly of claim 14, wherein the turn-to-secure coupler includes first and second parts that can be moved apart from one another to allow the turn-to-secure coupler to be installed on the connectorized cable assembly or removed from the connectorized cable assembly.

16. The connectorized cable assembly of claim 15, wherein the first and second parts each extend fully along an axial length of turn-to-secure coupler, the axial length extending along an axis of rotation of the turn-to-secure coupler about which the turn-to-secure coupler can turn relative to the connector core to secure the connector core to the fiber optic adapter, or the converter, or the dust cap.

17. The connectorized cable assembly of claim 16, wherein the first and second parts are each half-pieces of the turn-to-secure coupler.

18. The connectorized cable assembly of claim 16, wherein the first and second parts are configured to latch together.

19. The connector cable assembly of claim 18, wherein the first and second parts include axially extending edges connected by a hinge having a hinge axis that extends along the axis of rotation of the turn-to-secure coupler.

20. The connectorized cable assembly of claim 19, wherein first and second parts are moveable relative to one another about the hinge axis between an open position and a closed position.

21. The connectorized cable assembly of claim 20, wherein the hinge is a living hinge.

22. The connectorized cable assembly of claim 14, wherein the boot mounts on the turn-to-secure coupler.

23. A connectorized cable assembly comprising:
a fiber optic cable having an end, the fiber optic cable including a jacket containing at least one optical fiber and at least one strength member;
a connector core affixed at the end of the fiber optic cable, the connector core having a front end and a rear end, the strength member being anchored relative to the connector core at the rear end of the connector core when the connector core is affixed at the end of the fiber optic cable, and the rear end of the connector core being sealed relative to the jacket of the fiber optic cable when the connector core is affixed at the end of the fiber optic cable;
a seal carried by the connector core at an exterior of the connector core;
a ferrule positioned adjacent the front end of the connector core, the ferrule supporting a front end of the optical fiber or supporting an optical fiber stub spliced to the optical fiber; and
a rotatable coupler having a front extension forming a coupling portion for coupling the connector core to another structure and a rear extension configured to extend over a portion of the fiber optic cable behind the connector core;
the front extension being rotatably mounted over the connector core by sliding it in a rearward direction over the front end of the connector core and latching the front extension onto the connector core;
the rear extension having two pieces that are moveable relative to the front extension between an open position with the two pieces extending in a direction away from a central axis of the coupler, and a closed position with the two pieces extending in a direction that is parallel to the central axis of the coupler.

24. The connectorized cable assembly of claim 23, wherein the first and second pieces are connected to a rear end of the front extension by hinges defining pivot axes oriented transversely with respect to the central axis.

25. The connectorized cable assembly of claim 24, wherein the hinges are living hinges.

26. The connectorized cable assembly of claim 23, wherein the first and second pieces include inner stops adapted to oppose a feature on the connector core to limit rearward movement of the coupler relative to the connector core when the rear extension is in the closed position.

27. The connectorized cable assembly of claim 23, wherein the first and second pieces include a latch arrangement for latching the first and second pieces together in the closed position about the fiber optic cable.
